(19) United States
(12) Patent Application Publication
(10) Pub. No.: US 2025/0063522 A1
(43) Pub. Date: Feb. 20, 2025

(54) TIMING ADVANCE GROUP DETERMINATION FOR SUPPLEMENTARY UPLINK

(71) Applicant: QUALCOMM INCORPORATED, San Diego, CA (US)

(72) Inventors: Fang Yuan, Beijing (CN); Yan Zhou, San Diego, CA (US); Mostafa Khoshnevisan, San Diego, CA (US); Shaozhen Guo, Beijing (CN); Tao Luo, San Diego, CA (US); Peter Gaal, San Diego, CA (US); Junyi Li, Greentown, PA (US); Xiaoxia Zhang, San Diego, CA (US)

(21) Appl. No.: 18/720,558

(22) PCT Filed: Feb. 9, 2022
(86) PCT No.: PCT/CN2022/075675

§ 371 Date: Jun. 14, 2024

(51) Int. Cl. H04W 56/00; H04W 72/231

(52) U.S. Cl. CPC H04W 56/0045; H04W 72/231

(57) ABSTRACT

Methods, systems, and devices for wireless communications are described. A user equipment (UE) may communicating a first uplink message using a first uplink carrier and a first timing advance (TA) value associated with a first transmission configuration indicator (TCI) state and a second uplink message using a second uplink carrier and a second TA value associated with a second TCI state for the UE. The UE may receive a timing advance group (TAG) configuration which indicates a TA value to apply for a supplementary uplink (SUL) carrier of the serving cell, which is one of the first TA or second TA values. The UE may then transmit a SUL message using the SUL carrier of the serving cell in accordance with the TA value determined for the SUL carrier based on the TAG configuration for the UE.

### CROSS REFERENCE

The present Application is a 371 national stage filing of International PCT Application No. PCT/CN2022/075675 by Yuan et al. entitled “TIMING ADVANCE GROUP DETERMINATION FOR SUPPLEMENTARY UPLINK,” filed Feb. 9, 2022, which is assigned to the assignee hereof, and which is expressly incorporated by reference in its entirety herein.

### FIELD OF TECHNOLOGY

The following relates to wireless communications, including timing advance group (TAG) determination for supplementary uplink (SUL).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities or one or more network access nodes, each simultaneously supporting communication for multiple communication devices, which may be otherwise known as user equipment (UE).

### SUMMARY

The described techniques relate to improved methods, systems, devices, and apparatuses that support timing advance group (TAG) determination for supplementary uplink (SUL). Generally, the described techniques provide support for using a combination of multiple carriers into a single data channel to increase the data capacity and throughput of the network. For example, in some cases, a wireless device such as a user equipment (UE) may be configured to receive downlink communications via a downlink carrier and transmit uplink communications using two or more uplink carriers. To further increase uplink throughput and coverage, the UE may also be configured with a SUL carrier to increase throughput by utilizing other (e.g., lower or higher) frequency bands. The UE may also be configured to transmit the uplink communications using the uplink carriers in accordance with different timing advance (TA) values, such that the UE may adjust the timing that is applied for transmitting uplink communications on uplink carriers for synchronization with the network. In some implementations, the UE may be configured to apply a first TA value for the first uplink carrier and a second different TA value for the second uplink carrier, and may determine which of the two different TAs to apply to the SUL carrier.

The UE may use a number of different techniques to determine which TA to apply to the SUL carrier. In some examples, the UE may identify a parameter or identifier associated with the TA values, and may select the TA value to apply to the SUL carrier based on the TA that has the highest or lowest associated parameter or identifier. In some other examples, the UE may receive higher layer signaling (e.g., one or more radio resource control (RRC) messages) which indicate the TA (e.g., the TA associated with the first uplink carrier or the TA associated with the second uplink carrier) to apply to the SUL carrier. In some other examples, the UE may determine which TA to apply to the SUL based on an indication received in downlink control information (DCI).

A method for wireless communication at a UE is described. The method may include communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE, receiving a TAG configuration indicating a supplementary TA value for a SUL carrier of the serving cell, the TAG configuration indicating that the supplementary TA value is one of the first TA value of the first TAG or the second TA value of the second TAG for the SUL carrier, and transmitting a SUL message using the SUL carrier of the serving cell in accordance with the supplementary TA value based on the TAG configuration for the UE.

An apparatus for wireless communication at a UE is described. The apparatus may include a processor, memory coupled with the processor, and instructions stored in the memory. The instructions may be executable by the processor to cause the apparatus to communicate a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE, receive a TAG configuration indicating a supplementary TA value for a SUL carrier of the serving cell, the TAG configuration indicating that the supplementary TA value is one of the first TA value of the first TAG or the second TA value of the second TAG for the SUL carrier, and transmit a SUL message using the SUL carrier of the serving cell in accordance with the supplementary TA value based on the TAG configuration for the UE.

Another apparatus for wireless communication at a UE is described. The apparatus may include means for communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE, means for receiving a TAG configuration indicating a supplementary TA value for a SUL carrier of the serving cell, the TAG configuration indicating that the supplementary TA value is one of the first TA value of the first TAG or the second TA value of the second TAG for the SUL carrier, and means for transmitting a SUL message using the SUL carrier of the serving cell in accordance with the supplementary TA value based on the TAG configuration for the UE.

A non-transitory computer-readable medium storing code for wireless communication at a UE is described. The code may include instructions executable by a processor to communicate a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE, receive a TAG configuration indicating a supplementary TA value for a SUL carrier of the serving cell, the TAG configuration indicating that the supplementary TA value is one of the first TA value of the first TAG or the second TA value of the second TAG for the SUL carrier, and transmit a SUL message using the SUL carrier of the serving cell in accordance with the supplementary TA value based on the TAG configuration for the UE.

In some examples of the method, apparatuses, and non-transitory computer-readable medium described herein, the TAG configuration indicates a first identifier associated with the first TAG and a second identifier associated with the second TAG and the method, apparatuses, and non-transitory computer-readable medium may include further operations, features, means, or instructions for applying the first TAG or the second TAG for transmission of the SUL message using the SUL carrier based on a comparison of a first value of the first identifier and a second value of the second identifier.

In some examples of the method, apparatuses, and non-transitory computer-readable medium described herein, the comparison may include operations, features, means, or instructions for applying the first TA value of the first TAG for transmission of the SUL message using the SUL carrier based on the first value of the first identifier being greater than the second value of the second identifier.

In some examples of the method, apparatuses, and non-transitory computer-readable medium described herein, the comparison may include operations, features, means, or instructions for applying the first TA value of the first TAG for transmission of the SUL message using the SUL carrier based on the first value of the first identifier being less than the second value of the second identifier.

In some examples of the method, apparatuses, and non-transitory computer-readable medium described herein, the first identifier and the second identifier include transmission reception point identifiers, control resource set pool index identifiers, TAG identifiers, or any combination thereof.

Some examples of the method, apparatuses, and non-transitory computer-readable medium described herein may further include operations, features, means, or instructions for receiving a control message indicating which of the first TA value of the first TAG or the second TA value of the second TAG for the UE to apply for transmitting the SUL message using the SUL carrier of the serving cell.

In some examples of the method, apparatuses, and non-transitory computer-readable medium described herein, receiving the control message may include operations, features, means, or instructions for receiving a serving cell configuration that includes a TAG identifier, the TAG identifier indicating the first TA value of the first TAG or the second TA value of the second TAG.

In some examples of the method, apparatuses, and non-transitory computer-readable medium described herein, receiving the control message may include operations, features, means, or instructions for receiving a RRC message indicating the TAG configuration.

Some examples of the method, apparatuses, and non-transitory computer-readable medium described herein may further include operations, features, means, or instructions for receiving DCI that configures communications for the SUL message using the SUL carrier using the first transmission configuration indicator state or the second transmission configuration indicator state.

In some examples of the method, apparatuses, and non-transitory computer-readable medium described herein, the DCI indicates that the UE apply the first TA value of the first TAG for transmission of the SUL message using the SUL carrier based on the DCI being associated with the first transmission configuration indicator state, a first control resource set pool index, or both.

In some examples of the method, apparatuses, and non-transitory computer-readable medium described herein, the DCI indicates that the UE apply the second TA value of the second TAG for transmission of the SUL message using the SUL carrier based on the DCI being associated with the second transmission configuration indicator state, a second control resource set pool index, or both.

Some examples of the method, apparatuses, and non-transitory computer-readable medium described herein may further include operations, features, means, or instructions for receiving a RRC message that indicates the first TA value of the first TAG and the second TA value of the second TAG, receiving the DCI in accordance with the RRC message, and selecting the first TA value of the first TAG or the second TA value of the second TAG for transmission of the SUL message based on the DCI.

A method for wireless communication at a network device is described. The method may include receiving a first uplink message using a first uplink carrier of a serving cell in accordance with a first TA value of a first TAG configured for a UE, transmitting a TAG configuration indicating a supplementary TA value for a SUL carrier of the serving cell, the TAG configuration indicating that the supplementary TA value is one of the first TA value of the first TAG or a second TA value of a second TAG for the SUL carrier, and receiving a SUL message on the SUL carrier of the serving cell in accordance with the supplementary TA value based on the TAG configuration.

An apparatus for wireless communication at a network device is described. The apparatus may include a processor, memory coupled with the processor, and instructions stored in the memory. The instructions may be executable by the processor to cause the apparatus to receive a first uplink message using a first uplink carrier of a serving cell in accordance with a first TA value of a first TAG configured for a UE, transmit a TAG configuration indicating a supplementary TA value for a SUL carrier of the serving cell, the TAG configuration indicating that the supplementary TA value is one of the first TA value of the first TAG or a second TA value of a second TAG for the SUL carrier, and receive a SUL message on the SUL carrier of the serving cell in accordance with the supplementary TA value based on the TAG configuration.

Another apparatus for wireless communication at a network device is described. The apparatus may include means for receiving a first uplink message using a first uplink carrier of a serving cell in accordance with a first TA value of a first TAG configured for a UE, means for transmitting a TAG configuration indicating a supplementary TA value for a SUL carrier of the serving cell, the TAG configuration indicating that the supplementary TA value is one of the first TA value of the first TAG or a second TA value of a second TAG for the SUL carrier, and means for receiving a SUL message on the SUL carrier of the serving cell in accordance with the supplementary TA value based on the TAG configuration.

A non-transitory computer-readable medium storing code for wireless communication at a network device is described. The code may include instructions executable by a processor to receive a first uplink message using a first uplink carrier of a serving cell in accordance with a first TA value of a first TAG configured for a UE, transmit a TAG configuration indicating a supplementary TA value for a SUL carrier of the serving cell, the TAG configuration indicating that the supplementary TA value is one of the first TA value of the first TAG or a second TA value of a second TAG for the SUL carrier, and receive a SUL message on the SUL carrier of the serving cell in accordance with the supplementary TA value based on the TAG configuration.

Some examples of the method, apparatuses, and non-transitory computer-readable medium described herein may further include operations, features, means, or instructions for transmitting a control message indicating which one of the first TA value of the first TAG or the second TA value of the second TAG to apply for transmission of the SUL message.

In some examples of the method, apparatuses, and non-transitory computer-readable medium described herein, transmitting the control message may include operations, features, means, or instructions for transmitting a serving cell configuration that includes a TAG identifier indicating the first TAG or the second TAG.

In some examples of the method, apparatuses, and non-transitory computer-readable medium described herein, transmitting the control message may include operations, features, means, or instructions for transmitting a RRC message indicating the TAG configuration.

Some examples of the method, apparatuses, and non-transitory computer-readable medium described herein may further include operations, features, means, or instructions for transmitting DCI including the TAG configuration that indicates which one of the first TA value of the first TAG or the second TA value of the second TAG to apply for transmission of the SUL message.

In some examples of the method, apparatuses, and non-transitory computer-readable medium described herein, the DCI indicates that the UE apply the first TA value of the first TAG for transmission of the SUL message based on the DCI, a first control resource set pool index, or both.

In some examples of the method, apparatuses, and non-transitory computer-readable medium described herein, the DCI indicates that the UE apply the second TA value of the second TAG for transmission of the SUL message based on the DCI, a second control resource set pool index, or both.

In some examples of the method, apparatuses, and non-transitory computer-readable medium described herein, the TAG configuration indicates the first TA value of the first TAG or the second TA value of the second TAG based on a first identifier associated with the first TAG and a second identifier associated with the second TAG.

In some examples of the method, apparatuses, and non-transitory computer-readable medium described herein, the first identifier and the second identifier include transmission reception point identifiers, control resource set pool index identifiers, TAG identifiers, or any combination thereof.

### BRIEF DESCRIPTION OF THE DRAWINGS

FIGS. 1 and 2 illustrate example wireless communications systems that support timing advance group (TAG) determination for supplementary uplink (SUL) in accordance with aspects of the present disclosure.

FIGS. 3A and 3B illustrate examples of multi-transmission reception point (TRP) deployments that support TAG determination for SUL in accordance with aspects of the present disclosure.

FIGS. 4 and 5 illustrate example process flows that support TAG determination for SUL in accordance with aspects of the present disclosure.

FIGS. 6 and 7 show block diagrams of devices that support TAG determination for SUL in accordance with aspects of the present disclosure.

FIG. 8 shows a block diagram of a communications manager that supports TAG determination for SUL in accordance with aspects of the present disclosure.

FIG. 9 shows a diagram of a system including a device that supports TAG determination for SUL in accordance with aspects of the present disclosure.

FIGS. 10 and 11 show block diagrams of devices that support TAG determination for SUL in accordance with aspects of the present disclosure.

FIG. 12 shows a block diagram of a communications manager that supports TAG determination for SUL in accordance with aspects of the present disclosure.

FIG. 13 shows a diagram of a system including a device that supports TAG determination for SUL in accordance with aspects of the present disclosure.

FIGS. 14 through 18 show flowcharts illustrating methods that support TAG determination for SUL in accordance with aspects of the present disclosure.

### DETAILED DESCRIPTION

Some wireless communications systems may operate using a carrier aggregation deployment which includes a combining of multiple carriers into a single data channel of a serving cell to increase the data capacity of the network. For example, in some cases a device such as a user equipment (UE) may be configured to use a downlink carrier that is associated with two or more uplink carriers. To further increase uplink throughput, the UE may also be configured with a supplementary uplink (SUL) carrier which may utilize lower frequency bands.

In addition, a wireless communications system may support a multi-transmission reception point (TRP) operation to reduce signaling overhead and increase throughput. For example, the UE may transmit uplink communications with at least a first TRP and a second TRP using corresponding uplink carriers, and may also communicate with one of the first TRP or second TRP using a SUL carrier. In such cases, the network may configure the UE to transmit the uplink communications using different timing advance (TA) values, each of which may be associated with a respective TA group (TAG), in which the UE may adjust the timing that it sends uplink communications to network for synchronization purposes at the network. In some implementations, however, the UE may be configured to apply a first TA value for the first uplink carrier and a second different TA value for the second uplink carrier, but may determine which of the two different TAs to apply to the SUL carrier.

The UE may use a number of different techniques to determine which TA to apply to the SUL carrier. In some examples, the UE may identify a parameter or identifier associated with the TA values, and may select the TA value to apply to the SUL carrier based on the TA that has the highest or lowest associated parameter or identifier. In some other examples, the UE may receive higher layer signaling (e.g., radio resource control (RRC) signaling) which indicates the TA (e.g., either the TA associated with the first uplink carrier or the TA associated with the second uplink carrier) to apply to the SUL carrier. In some other examples, the UE may determine which TA to apply to the SUL based on an indication received in downlink control information (DCI).

Aspects of the disclosure are initially described in the context of wireless communications systems. Aspects of the disclosure are further illustrated by and described with reference to apparatus diagrams, system diagrams, multi-TRP deployment diagrams, process flows, and flowcharts that relate to TAG determination for SUL.

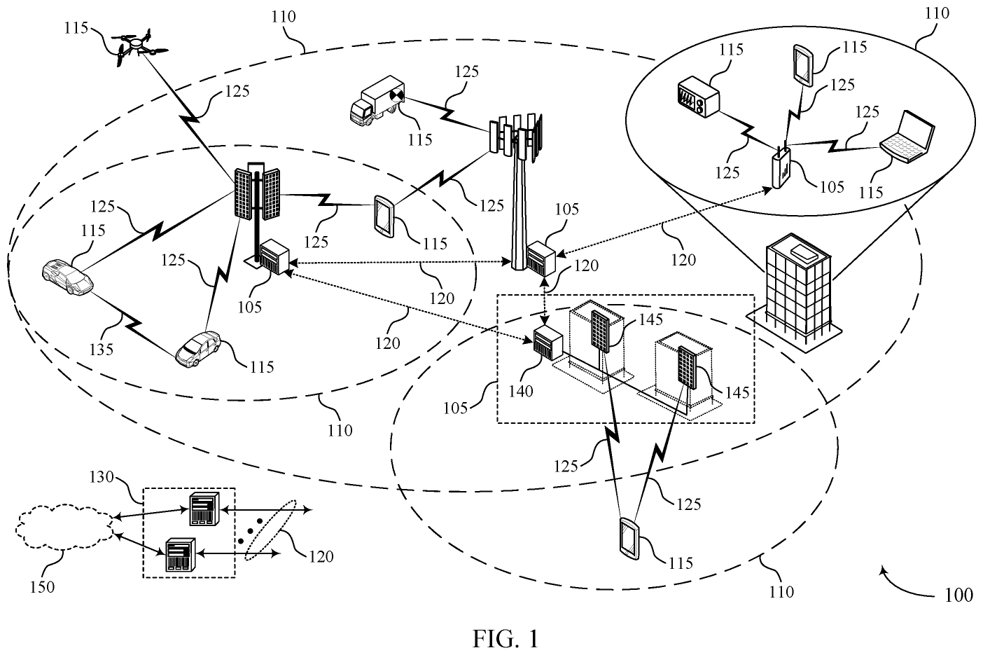

FIG. 1 illustrates an example of a wireless communications system 100 that supports TAG determination for SUL in accordance with aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The network entities 105 may be dispersed throughout a geographic area to form the wireless communications system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, network entity 105, entity of a core network 130, apparatus, device, or computing system configured to perform any techniques described herein. For example, a network node may be a UE 115. As another example, a network node may be a network entity 105. As another example, a first network node may be configured to communicate with a second network node or a third network node. In one aspect of this example, the first network node may be a UE 115, the second network node may be a network entity 105, and the third network node may be a UE 115. In another aspect of this example, the first network node may be a UE 115, the second network node may be a network entity 105, and the third network node may be a network entity 105. In yet other aspects of this example, the first, second, and third network nodes may be different. Similarly, reference to a UE 115, a network entity 105, an apparatus, a device, or a computing system may include disclosure of the UE 115, network entity 105, apparatus, device, or computing system being a network node. For example, disclosure that a UE 115 is configured to receive information from a network entity 105 also discloses that a first network node is configured to receive information from a second network node. In this example, consistent with this disclosure, the first network node may refer to a first UE 115, a first network entity 105, a first apparatus, a first device, or a first computing system configured to receive the information; and the second network node may refer to a second UE 115, a second network entity 105, a second apparatus, a second device, or a second computing system.

The network entities 105 may communicate with the core network 130, or with one another, or both. For example, the network entities 105 may interface with the core network 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via core network 130), or both. In some examples, the backhaul links 120 may be or include one or more wireless links.

One or more of the network entities 105 described herein may include or may be referred to by a person having ordinary skill in the art as a base transceiver station, a radio network entity, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay network entities, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network devices (e.g., radio heads and ANCs) or consolidated into a single network device (e.g., a network entity 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the physical layer, transport channels may be mapped to physical channels.

Wireless communications system 100 may support a combining of multiple carriers into a single data channel of the serving cell 105-a to increase the data capacity and throughput of the network. For example, in some cases, a UE 115 may be configured to receive downlink communications via a downlink carrier, and transmit uplink communications with two or more uplink carriers. To further increase uplink throughput, the UE 115 may also be configured with a SUL carrier.

The UE 115 may be further configured to transmit the uplink communications using the uplink carriers using different TA values, such that the UE 115 may adjust the timing that it sends uplink communications to a network entity 105-a for synchronization at the network. In some implementations, however, the UE 115 may be configured to apply a first TA value for the first uplink carrier and a second different TA value for the second uplink carrier, but may determine which of the two different TAs to apply to the SUL carrier.

In some examples, the UE 115 may identify a parameter or identifier associated with the TA values, and may select the TA value to apply to the SUL carrier based on the TA that has the highest or lowest associated parameter or identifier. In some other examples, the UE 115 may receive one or more RRC messages which indicate the TA to apply to the SUL carrier. In some other examples, the UE 115 may determine which TA to apply to the SUL based on an indication received in DCI.

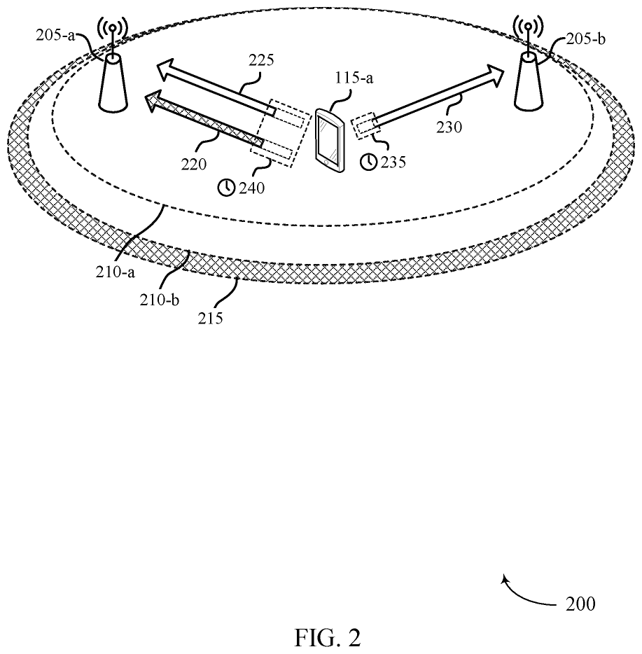

FIG. 2 illustrates an example of a wireless communications system 200 that supports TAG determination for SUL in accordance with aspects of the present disclosure. For example, wireless communications system 200 may support communications between a UE 115-a which may be an example of a UE 115 described with reference to FIG. 1, and two TRPs 205-a and 205-b which may be examples of corresponding network devices (e.g., network entities 105 or components of a network entity 105) described with reference to FIG. 1.

Some wireless communications systems (for example, high frequency systems such as 5G/NR systems supporting communications using frequency bands above a threshold), may support combining multiple carriers into a single data channel on a serving cell to increase the data capacity of the network. In some cases, a devices such as a UE may be configured to use a downlink carrier that is associated with two or more uplink carriers 210-a and 210-b in a serving cell. In addition, to increase uplink performance and throughput, the UE may also be configured with a SUL carrier 215 which may be located in lower frequency bands (with respect to the downlink and uplink carriers), thereby providing increased uplink coverage for high frequency deployments.

Wireless communications system 200 may further support multi-DCI, multi-TRP operation to reduce signaling overhead and increase throughput. For example, the UE 115-a may communicate with TRP 205-a and TRP 205-b using frequencies allocated for the corresponding uplink and downlink carriers configured for the UE 115-a. In some examples, the UE 115-a may communicate simultaneous uplink transmissions 225 and 230 using the corresponding uplink carriers 210-a and 210-b, and may also communicate a SUL transmission 220 on the SUL carrier 215. Uplink transmissions on the uplink carriers and the SUL carrier 215 may be configured by the network to avoid overlapping physical uplink shared channel (PUSCH) or physical uplink control channel (PUCCH) transmissions in time.

Further, the network may configure the UE 115-a to transmit the uplink communications using different TA values, in which the UE 115-a may adjust the timing in which the UE 115-a sends uplink communications so that the uplink transmissions are synchronized when received by the network. For example, the UE 115-a may receive a TA value (e.g., NTA offset) which indicates a timing offset (e.g., nTimingAdvanceOffset) for the serving cell, or the UE 115-a may determine a default TA value (e.g., NTA offset) for the serving cell based on various factor such as system frequency and subcarrier spacing. The TA may be further associated with a TA group (TAG), which may include one or more serving cells with the same uplink TA and same downlink timing reference cell to further increase network timing synchronization.

In some cases, the UE 115-a may apply a same TA value to two uplink carriers in the serving cell. For example, a same TA may apply to communications on the SUL carrier and one of the uplink carriers. In some implementations, however, the UE 115-a may be configured to apply a first TA value for the first uplink carrier 210-a, and a second different TA value for the second uplink carrier 210-b, and the UE 115-a may determine which of the two different TAs to apply to the SUL carrier 215.

In some examples, the UE 115-a may identify a number of parameters or identifiers associated with the TA values for communications with the TRP 205-a and the TRP 205-b, and may select the TA based on a predetermined rule for an evaluation of these parameters. In an example of the rule, the UE 115-a may identify a TRP ID, a CORESETpoolindex ID, a physical cell identifier (PCI), a close loop index, a TAG ID, or other parameters associated with each applied TA, and may select the TA value to apply to the SUL carrier based on the TA that has the highest associated TRP ID, CORESETpoolindex ID, a PCI, a close loop index, or TAG ID value. Additionally or alternatively, the UE 115-a may select the TA value to apply to the SUL carrier based on the TA that has the lowest associated TRP ID, CORESETpoolindex ID, a PCI, a close loop index, or TAG ID value. In some examples, the predetermined rule may allow the UE 115-a to select a default TA for the SUL.

In some other examples, the UE may receive higher layer signaling which indicates the TA (e.g., either TA 235 or 240) to apply to the SUL carrier. For example, the UE may receive a RRC or MAC-CE message which specifies a TA or TAG to apply to the SUL. The RRC or MAC-CE message may indicate that the UE 115-a apply the TA 240 associated with the first uplink carrier 210-a, or the RRC message may indicate that the UE 115-a apply the TA 235 associated with the second uplink carrier 210-b.

In some other examples, the UE 115-a may determine which TA to apply to the SUL based on an indication received in the DCI. For example, the UE 115-a may receive a DCI which schedules the SUL transmission 220, and may apply the same TA to the SUL as the TA associated with the DCI scheduling the SUL. In some other cases, the DCI may include an indicator which explicitly indicates which TA (e.g., 235 or 240) to apply for the SUL). For example, the UE 115-a may receive DCIs in different CORESETs, where different CORESETs may be configured with different CORESET pool indexes. If the UE 115-a receives a DCI scheduling an uplink transmission using SUL carrier in a CORESET of CORESET pool index 0 or of no CORESET pool index, the UE 115-a may apply the TA from a TAG associated with the CORESET pool index 0, and if the UE 115-a receives a DCI scheduling an uplink transmission using SUL carrier in a CORESET of CORESET pool index 1, the UE 115-a may apply the TA from a TAG associated with the CORESET pool index 1.

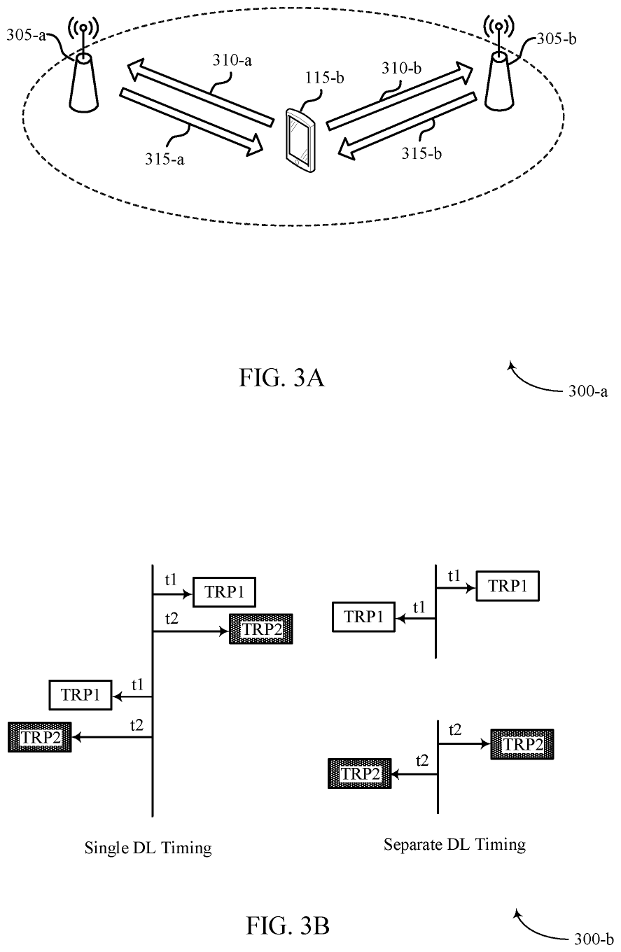

FIGS. 3A and 3B illustrate example multi-TRP deployments 300-a and 300-b in a wireless communications system that supports TAG determination for SUL in accordance with aspects of the present disclosure. For example, multi-TRP deployments 300-a and 300-b may support communications between a UE 115-b which may be an example of a UE 115 described with reference to FIGS. 1 and 2, and two TRPs 305-a and 305-b which may be examples of corresponding network devices described with reference to FIGS. 1 and 2.

Wireless communications system 300-a may be an example of a wireless communications system that supports multi-DCI multi-TRP communications, in which the network may communicate with the UE 115-b using multiple TRPs (e.g., TRP 305-a and 305-b). TRP 305-a and TRP 305-b may transmit different physical downlink shared channel (PDSCH) and each TRP is transmitting its own corresponding physical downlink control channel (PDCCH) 315-a and 315-b, and DCI. In some cases, the multi-DCI multi-TRP communications may of wireless communications network 300-a may support multiple uplink carriers and a downlink carrier for communications on a serving cell. In some examples, the wireless communications system 300-a may support common TCI states for downlink communications (e.g., downlink data and downlink resource assignment of the same UE), including downlink common beam.

In some examples, the wireless communications system 300-a may support L1/L2-centric inter-cell mobility facilitated by information such as physical cell identifier (PCI), SSB/TRS indicator TAGs, L1-RSRP report for reference signaling. Additionally or alternatively, wireless communications system 300-a may support advanced beam refinement and tracking for high-mobility devices and devices having a large number of configured TCI states with a unified TCI framework and multi-panel UE support. In addition, each of the uplink communications 310-a and 310-b (which may be uplink transmissions or SUL transmissions) may be associated with different TAs applied by the UE 115-b.

Multi-TRP configuration 300-b may include a configuration for applying different TAs for multi-DCI multi-TRP operations in a wireless communications network. In some examples, single downlink (DL) timing may be applied for a multi-TRP deployment, where a first TA value (e.g., t1) is applied for communications between a UE and a first TRP (e.g., TRP1) jointly with a second TA value (e.g., t2) that is applied for communications between the UE and a second TRP (e.g., TRP 2).

In some other examples, separate DL timing may be applied for a multi-TRP deployment, where a first TA value (e.g., t1) is applied for communications between the UE and TRP 1, and a second TA value (e.g., t2) is applied for communications between the UE and TRP2.

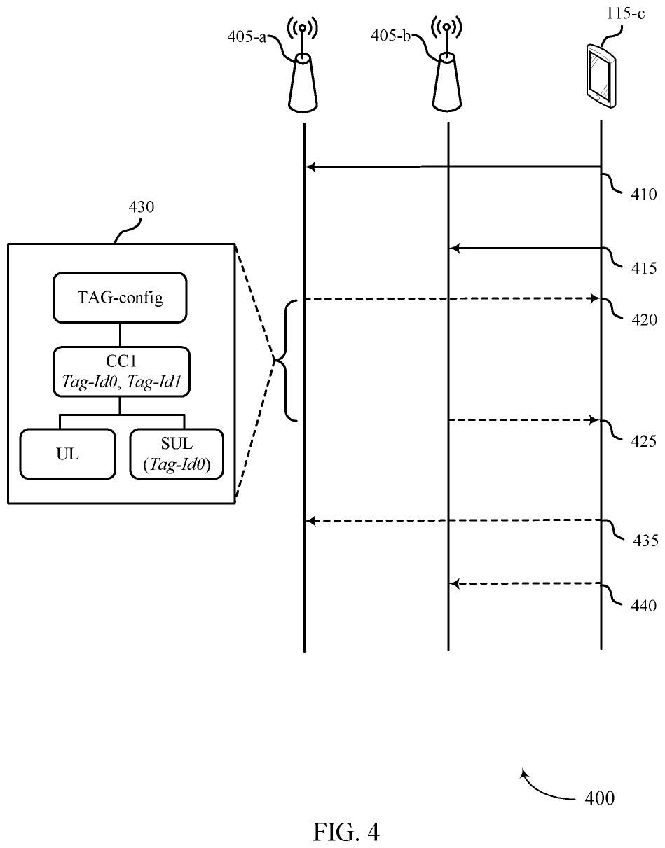

FIG. 4 illustrates an example of a process flow 400 that supports TAG determination for SUL in accordance with aspects of the present disclosure. The process flow 400 may implement aspects of wireless communications systems 100 and 200, or may be implemented by aspects of the wireless communications systems 100 and 200. For example, the process flow 400 may illustrate operations between a UE 115-c and TRPs 405-a and 405-b, which may be examples of corresponding devices described with reference to FIGS. 1 and 2. In the following description of the process flow 400, the operations between the devices may be transmitted in a different order than the example order shown, or the operations may be performed in different orders or at different times or by different devices. Additionally or alternatively, some operations may also be omitted from the process flow 400, and other operations may be added to the process flow 400.

At 410, the UE 115-c may transmit to a first TRP 405-a, a first uplink message using a first uplink carrier of a serving cell in accordance with a first TA value of a first TAG associated with a first TCI state for the UE 115-c.

At 415, the UE 115-c may transmit to a second TRP 405-b, a second uplink message using a second uplink carrier of a serving cell in accordance with a second TA value of a second TAG associated with a second TCI state for the UE 115-c.

At 420 or 425, the UE 115-c may receive a TAG configuration which indicates a SUL TA value for a SUL carrier of the serving cell, TAG configuration 430 indicating that the SUL TA value is one of the first TA value of the first TAG or the second TA value of the second TAG for the SUL carrier.

In some examples, the TAG configuration 430 may be a transmitted to the UE 115-c in an RRC message or other higher layer signaling. For example a medium access control (MAC) cell group configuration (e.g., MAC-CellGroupConfig) may indicate a TAG configuration (e.g., Tag-config) which further indicates a serving cell configuration (e.g., ServingCellConfig) for the serving cell of the UE 115-c. The serving cell configuration may indicate a number of TAG identifiers (e.g., Tag-Id0, Tag-Id1) configured for a component carrier of the serving cell. An example configuration for the serving cell configuration may include:

```
ServingCellConfig ::= SEQUENCE {
  ...
  tag-Id0, TAG-Id
  tag-Id1, TAG-Id
  uplinkConfig, UplinkConfig
  supplementaryUplink, UplinkConfig
  ...
}
```

The serving cell configuration may further indicate a specific TAG ID (e.g., tagIdforSUL) that the UE 115-c may apply for the SUL carrier. For example, the uplink configuration may include a number of different parameters, including:

```
UplinkConfig ::= SEQUENCE {
  ...
  uplinkBWP-ToReleaseList
  uplinkBWP-ToAddModList
  pusch-ServingCellConfig
  tagIdforSUL, Tag-Id
  ...
}
```

In such examples, the RRC parameter tagIdforSUL may indicate the TAG that the UE may apply for the communications using the SUL carrier. For example, the RRC parameter tagIdforSUL may be one bit, where a bit value of 0 indicates the first TAG is applied to SUL, and a bit value of 1 indicates the second TAG is applied to SUL. In cases that the TAG configuration 430 indicates that the UE 115-c apply the first TA value associated with the first uplink carrier, the UE 115-c may transmit a SUL message to the first TRP 405-a at 435 in accordance with the first TA value. In cases that the TAG configuration 430 indicates that the UE 115-c apply the second TA value associated with the second uplink carrier, the UE 115-c may transmit the SUL message to the second TRP 405-b at 440 in accordance with the second TA value.

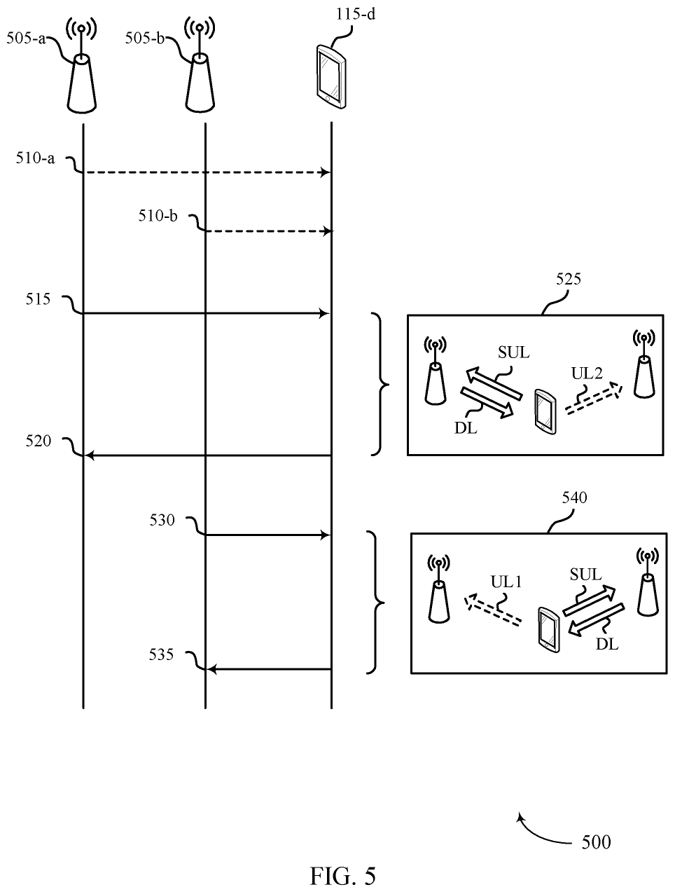

FIG. 5 illustrates an example of a process flow 500 that supports TAG determination for SUL in accordance with aspects of the present disclosure. The process flow 500 may implement aspects of wireless communications systems 100 and 200, or may be implemented by aspects of the wireless communications systems 100 and 200. For example, the process flow 500 may illustrate operations between a UE 115-d and TRPs 505-a and 505-b, which may be examples of corresponding devices described with reference to FIGS. 1 and 2. In the following description of the process flow 500, the operations between the devices may be transmitted in a different order than the example order shown, or the operations may be performed in different orders or at different times or by different devices. Additionally or alternatively, some operations may also be omitted from the process flow 500, and other operations may be added to the process flow 500.

At 510-a or 510-b, the UE 115-d may receive RRC signaling (or other higher layer signaling) which includes serving cell configuration including a number of TAG identifiers (e.g., TAG0 and TAG1).

At 515, the UE 115-d may receive a first DCI (e.g., DCI0) in a CORESET having a first CORESET pool index (e.g., CORESETpoolindex=0). In such cases, the DCI may configure the UE 115-d with a first TA value associated with a TAG (e.g., TAG0) associated with the CORESET pool index for the first DCI, and the UE 115-d may apply the first TA to a SUL transmission at 520.

At 525 the UE 115-d may communicate with TRP 505-a using the SUL carrier using the TA of the first uplink carrier in accordance with the TAG configuration as indicated by the first DCI. Additionally or alternatively, the UE 115-d may receive downlink communications on a downlink carrier of the serving cell and may transmit uplink messages using one or more uplink carriers in addition to the SUL carrier.

At 530, the UE 115-d may receive a second DCI (e.g., DCI1) in a CORESET having a second CORESET pool index (e.g., CORESETpoolindex=1). In such cases, the DCI may configure the UE 115-d with a first TA value associated with a TAG (e.g., TAG1) associated with the CORESET pool index for the second DCI, and the UE 115-d may apply the second TA to a SUL transmission at 535.

At 540 the UE 115-d may communicate with TRP 505-b using the SUL carrier using the TA of the second uplink carrier in accordance with the TAG configuration as indicated by the second DCI. Additionally or alternatively, the UE 115-d may receive downlink communications on a downlink carrier of the serving cell and may transmit uplink messages using one or more uplink carriers in addition to the SUL carrier.

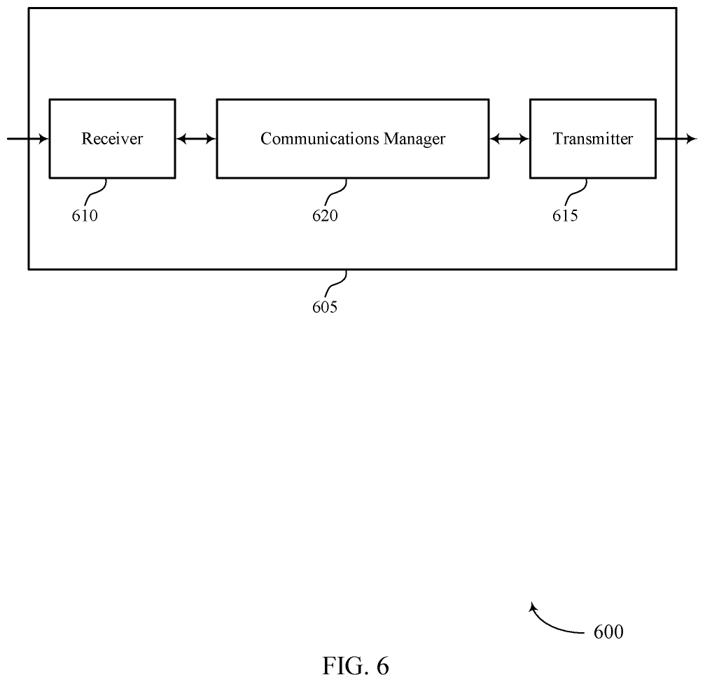

FIG. 6 shows a block diagram 600 of a device 605 that supports TAG determination for SUL in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to TAG determination for SUL). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to TAG determination for SUL). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of TAG determination for SUL as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE. The communications manager 620 may be configured as or otherwise support a means for receiving a TAG configuration indicating a supplementary TA value for a SUL carrier of the serving cell, the TAG configuration indicating that the supplementary TA value is one of the first TA value of the first TAG or the second TA value of the second TAG for the SUL carrier. The communications manager 620 may be configured as or otherwise support a means for transmitting a SUL message using the SUL carrier of the serving cell in accordance with the supplementary TA value based on the TAG configuration for the UE.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, reduced power consumption, more efficient utilization of communication resources, increased throughput, and enhanced uplink performance.

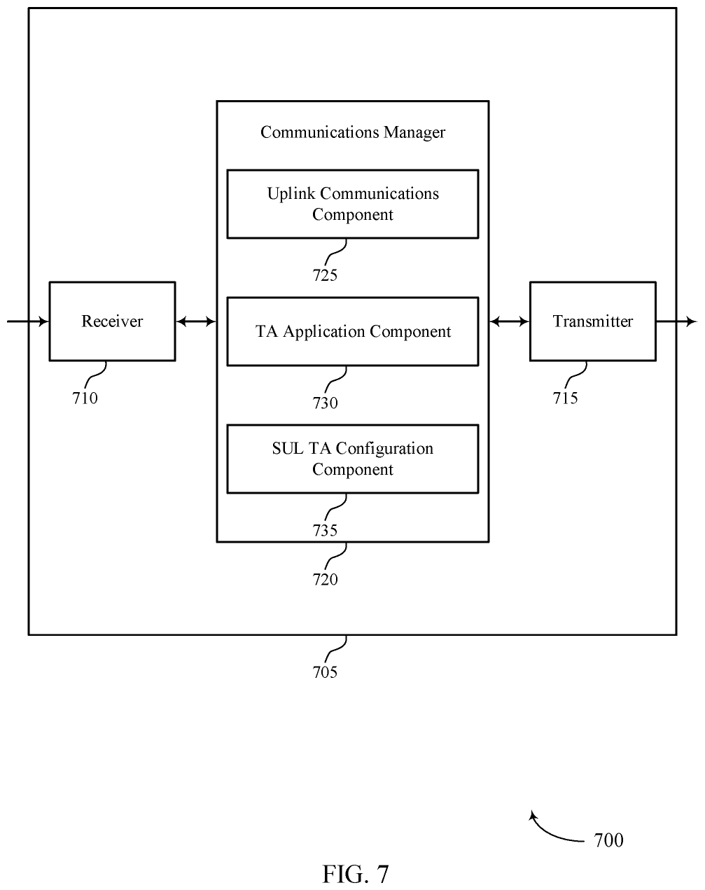

FIG. 7 shows a block diagram 700 of a device 705 that supports TAG determination for SUL in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to TAG determination for SUL). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to TAG determination for SUL). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of TAG determination for SUL as described herein. For example, the communications manager 720 may include an uplink communications component 725, a TA application component 730, an SUL TA configuration component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The uplink communications component 725 may be configured as or otherwise support a means for communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE. The TA application component 730 may be configured as or otherwise support a means for receiving a TAG configuration indicating a supplementary TA value for a SUL carrier of the serving cell, the TAG configuration indicating that the supplementary TA value is one of the first TA value of the first TAG or the second TA value of the second TAG for the SUL carrier. The SUL TA configuration component 735 may be configured as or otherwise support a means for transmitting a SUL message using the SUL carrier of the serving cell in accordance with the supplementary TA value based on the TAG configuration for the UE.

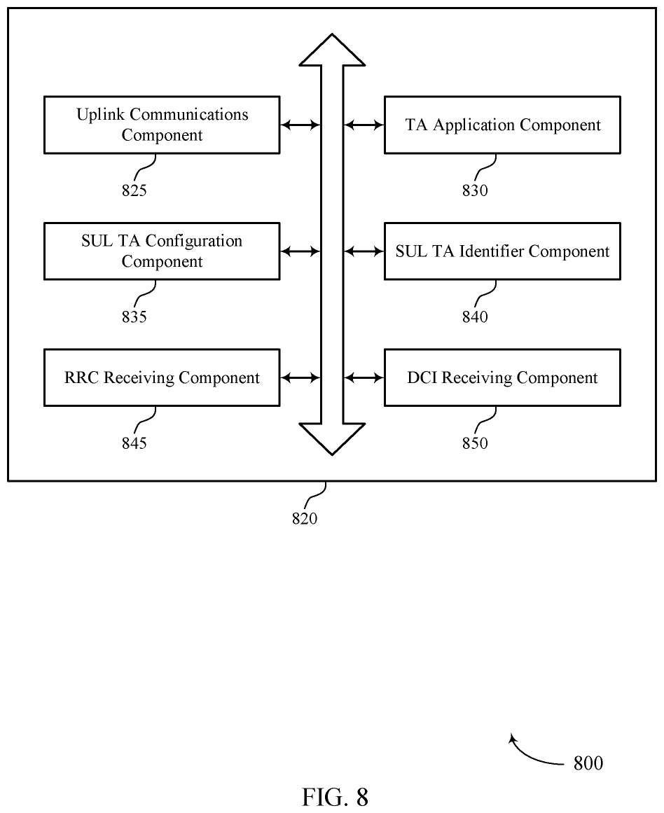

FIG. 8 shows a block diagram 800 of a communications manager 820 that supports TAG determination for SUL in accordance with aspects of the present disclosure. The communications manager 820 may be an example of aspects of a communications manager 620, a communications manager 720, or both, as described herein. The communications manager 820, or various components thereof, may be an example of means for performing various aspects of TAG determination for SUL as described herein. For example, the communications manager 820 may include an uplink communications component 825, a TA application component 830, an SUL TA configuration component 835, an SUL TA identifier component 840, an RRC receiving component 845, a DCI receiving component 850, or any combination thereof. Each of these components may communicate, directly or indirectly, with one another (e.g., via one or more buses).

The communications manager 820 may support wireless communication at a UE in accordance with examples as disclosed herein. The uplink communications component 825 may be configured as or otherwise support a means for communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE. The TA application component 830 may be configured as or otherwise support a means for receiving a TAG configuration indicating a supplementary TA value for a SUL carrier of the serving cell, the TAG configuration indicating that the supplementary TA value is one of the first TA value of the first TAG or the second TA value of the second TAG for the SUL carrier. The SUL TA configuration component 835 may be configured as or otherwise support a means for transmitting a SUL message using the SUL carrier of the serving cell in accordance with the supplementary TA value based on the TAG configuration for the UE.

In some examples, the TAG configuration indicates a first identifier associated with the first TAG and a second identifier associated with the second TAG, and the SUL TA identifier component 840 may be configured as or otherwise support a means for applying the first TAG or the second TAG for transmission of the SUL message using the SUL carrier based on a comparison of a first value of the first identifier and a second value of the second identifier.

In some examples, to support comparison, the SUL TA identifier component 840 may be configured as or otherwise support a means for applying the first TA value of the first TAG for transmission of the SUL message using the SUL carrier based on the first value of the first identifier being greater than the second value of the second identifier.

In some examples, to support comparison, the SUL TA identifier component 840 may be configured as or otherwise support a means for applying the first TA value of the first TAG for transmission of the SUL message using the SUL carrier based on the first value of the first identifier being less than the second value of the second identifier.

In some examples, the first identifier and the second identifier include transmission reception point identifiers, control resource set pool index identifiers, TAG identifiers, or any combination thereof.

In some examples, the RRC receiving component 845 may be configured as or otherwise support a means for receiving a control message indicating which of the first TA value of the first TAG or the second TA value of the second TAG for the UE to apply for transmitting the SUL message using the SUL carrier of the serving cell.

In some examples, to support receiving the control message, the RRC receiving component 845 may be configured as or otherwise support a means for receiving a serving cell configuration that includes a TAG identifier, the TAG identifier indicating the first TA value of the first TAG or the second TA value of the second TAG.

In some examples, to support receiving the control message, the RRC receiving component 845 may be configured as or otherwise support a means for receiving a RRC message indicating the TAG configuration.

In some examples, the DCI receiving component 850 may be configured as or otherwise support a means for receiving DCI that configures communications for the SUL message using the SUL carrier using the first transmission configuration indicator state or the second transmission configuration indicator state.

In some examples, the DCI indicates that the UE apply the first TA value of the first TAG for transmission of the SUL message using the SUL carrier based on the DCI being associated with the first transmission configuration indicator state, a first control resource set pool index, or both.

In some examples, the DCI indicates that the UE apply the second TA value of the second TAG for transmission of the SUL message using the SUL carrier based on the DCI being associated with the second transmission configuration indicator state, a second control resource set pool index, or both.

In some examples, the RRC receiving component 845 may be configured as or otherwise support a means for receiving a RRC message that indicates the first TA value of the first TAG and the second TA value of the second TAG. In some examples, the DCI receiving component 850 may be configured as or otherwise support a means for receiving the DCI in accordance with the RRC message. In some examples, the SUL TA configuration component 835 may be configured as or otherwise support a means for selecting the first TA value of the first TAG or the second TA value of the second TAG for transmission of the SUL message based on the DCI.

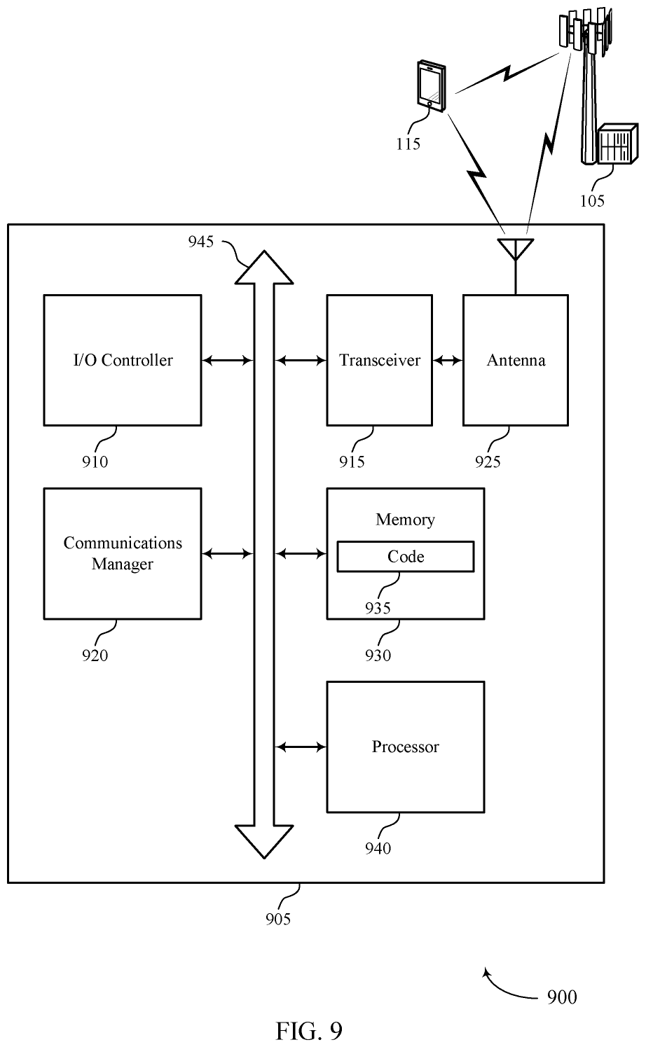

FIG. 9 shows a diagram of a system 900 including a device 905 that supports TAG determination for SUL in accordance with aspects of the present disclosure. The device 905 may be an example of or include the components of a device 605, a device 705, or a UE 115 as described herein. The device 905 may communicate wirelessly with one or more network entities 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting TAG determination for SUL). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE. The communications manager 920 may be configured as or otherwise support a means for receiving a TAG configuration indicating a supplementary TA value for a SUL carrier of the serving cell, the TAG configuration indicating that the supplementary TA value is one of the first TA value of the first TAG or the second TA value of the second TAG for the SUL carrier. The communications manager 920 may be configured as or otherwise support a means for transmitting a SUL message using the SUL carrier of the serving cell in accordance with the supplementary TA value based on the TAG configuration for the UE.

By including or configuring the communications manager 920 in accordance with examples as described herein, the device 905 may support techniques for improved communication reliability, reduced latency, improved user experience based on increased throughput, more efficient utilization of communication resources, improved coordination and synchronization between devices, and increased uplink coverage and performance.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of TAG determination for SUL as described herein, or the processor 940 and the memory 930 may be otherwise configured to perform or support such operations.

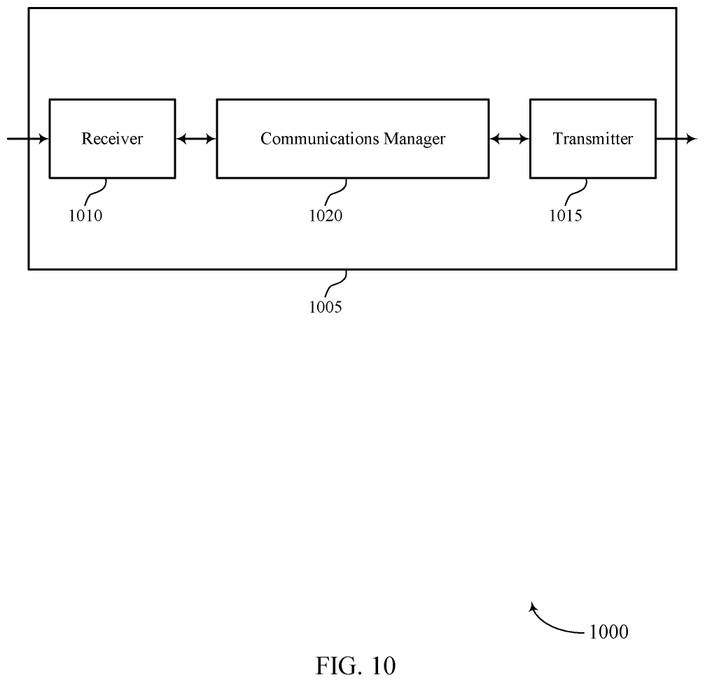

FIG. 10 shows a block diagram 1000 of a device 1005 that supports TAG determination for SUL in accordance with aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to TAG determination for SUL). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to TAG determination for SUL). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of TAG determination for SUL as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network device in accordance with examples as disclosed herein. For example, the communications manager 1020 may be configured as or otherwise support a means for receiving a first uplink message using a first uplink carrier of a serving cell in accordance with a first TA value of a first TAG configured for a UE. The communications manager 1020 may be configured as or otherwise support a means for transmitting a TAG configuration indicating a supplementary TA value for a SUL carrier of the serving cell, the TAG configuration indicating that the supplementary TA value is one of the first TA value of the first TAG or a second TA value of a second TAG for the SUL carrier. The communications manager 1020 may be configured as or otherwise support a means for receiving a SUL message on the SUL carrier of the serving cell in accordance with the supplementary TA value based on the TAG configuration.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing, reduced power consumption, more efficient utilization of communication resources, increased throughput, and enhanced uplink performance.

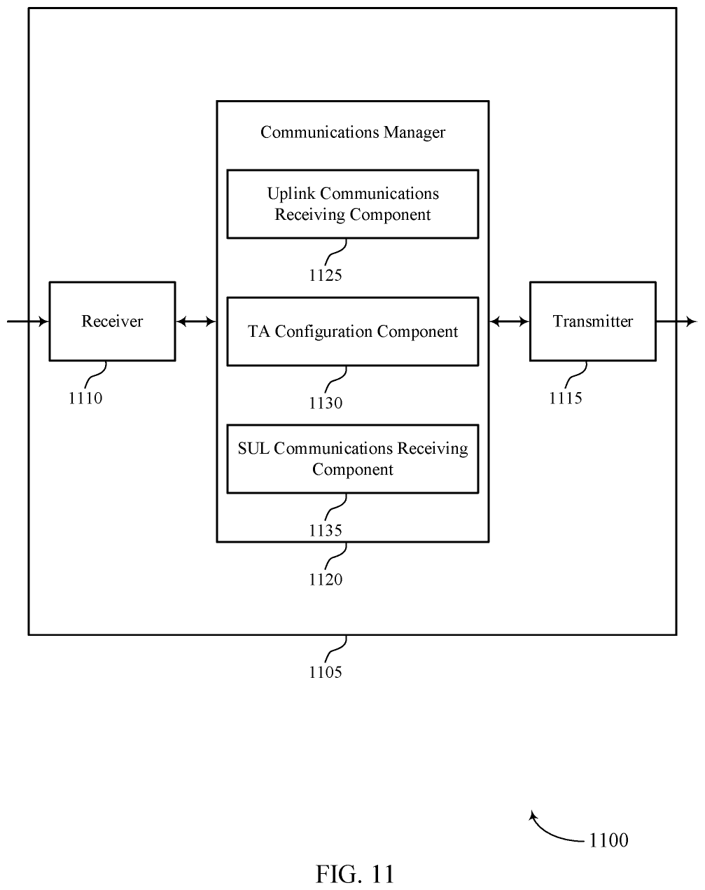

FIG. 11 shows a block diagram 1100 of a device 1105 that supports TAG determination for SUL in accordance with aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to TAG determination for SUL). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to TAG determination for SUL). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of TAG determination for SUL as described herein. For example, the communications manager 1120 may include an uplink communications receiving component 1125, a TA configuration component 1130, an SUL communications receiving component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a network device in accordance with examples as disclosed herein. The uplink communications receiving component 1125 may be configured as or otherwise support a means for receiving a first uplink message using a first uplink carrier of a serving cell in accordance with a first TA value of a first TAG configured for a UE. The TA configuration component 1130 may be configured as or otherwise support a means for transmitting a TAG configuration indicating a supplementary TA value for a SUL carrier of the serving cell, the TAG configuration indicating that the supplementary TA value is one of the first TA value of the first TAG or a second TA value of a second TAG for the SUL carrier. The SUL communications receiving component 1135 may be configured as or otherwise support a means for receiving a SUL message on the SUL carrier of the serving cell in accordance with the supplementary TA value based on the TAG configuration.

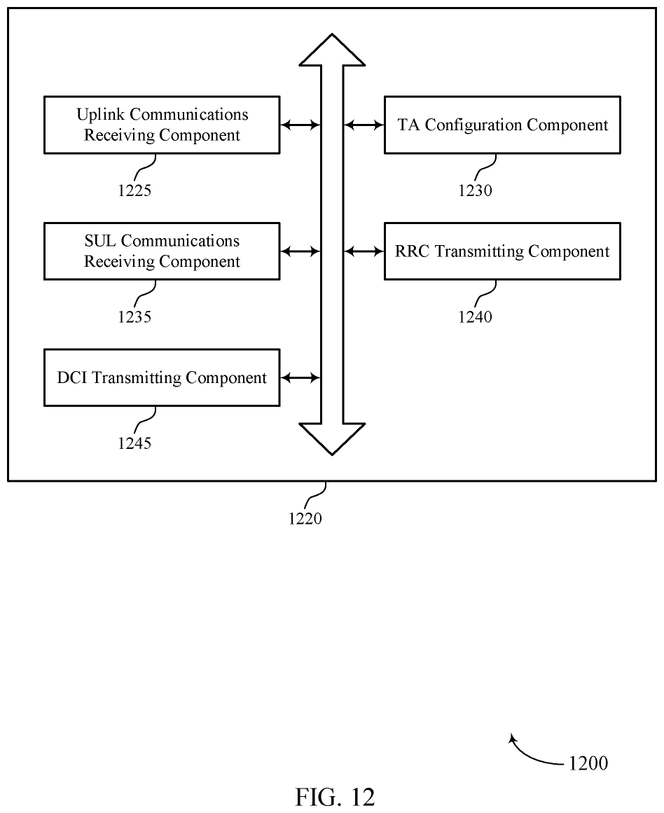

FIG. 12 shows a block diagram 1200 of a communications manager 1220 that supports TAG determination for SUL in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of TAG determination for SUL as described herein. For example, the communications manager 1220 may include an uplink communications receiving component 1225, a TA configuration component 1230, an SUL communications receiving component 1235, an RRC transmitting component 1240, a DCI transmitting component 1245, or any combination thereof. Each of these components may communicate, directly or indirectly, with one another (e.g., via one or more buses).

The communications manager 1220 may support wireless communication at a network device in accordance with examples as disclosed herein. The uplink communications receiving component 1225 may be configured as or otherwise support a means for receiving a first uplink message using a first uplink carrier of a serving cell in accordance with a first TA value of a first TAG configured for a UE. The TA configuration component 1230 may be configured as or otherwise support a means for transmitting a TAG configuration indicating a supplementary TA value for a SUL carrier of the serving cell, the TAG configuration indicating that the supplementary TA value is one of the first TA value of the first TAG or a second TA value of a second TAG for the SUL carrier. The SUL communications receiving component 1235 may be configured as or otherwise support a means for receiving a SUL message on the SUL carrier of the serving cell in accordance with the supplementary TA value based on the TAG configuration.

In some examples, the RRC transmitting component 1240 may be configured as or otherwise support a means for transmitting a control message indicating which one of the first TA value of the first TAG or the second TA value of the second TAG to apply for transmission of the SUL message.

In some examples, to support transmitting the control message, the RRC transmitting component 1240 may be configured as or otherwise support a means for transmitting a serving cell configuration that includes a TAG identifier indicating the first TAG or the second TAG.

In some examples, to support transmitting the control message, the RRC transmitting component 1240 may be configured as or otherwise support a means for transmitting a RRC message indicating the TAG configuration.

In some examples, the DCI transmitting component 1245 may be configured as or otherwise support a means for transmitting DCI including the TAG configuration that indicates which one of the first TA value of the first TAG or the second TA value of the second TAG to apply for transmission of the SUL message.

In some examples, the DCI indicates that the UE apply the first TA value of the first TAG for transmission of the SUL message based on the DCI, a first control resource set pool index, or both.

In some examples, the DCI indicates that the UE apply the second TA value of the second TAG for transmission of the SUL message based on the DCI, a second control resource set pool index, or both.

In some examples, the TAG configuration indicates the first TA value of the first TAG or the second TA value of the second TAG based on a first identifier associated with the first TAG and a second identifier associated with the second TAG.

In some examples, the first identifier and the second identifier include transmission reception point identifiers, control resource set pool index identifiers, TAG identifiers, or any combination thereof.

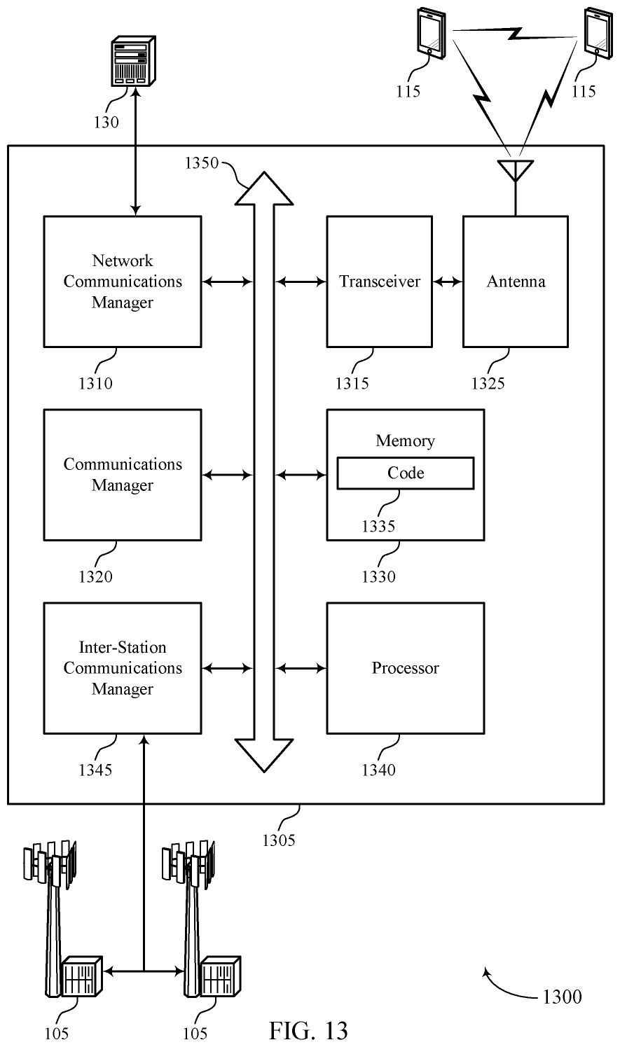

FIG. 13 shows a diagram of a system 1300 including a device 1305 that supports TAG determination for SUL in accordance with aspects of the present disclosure. The device 1305 may be an example of or include the components of a device 1005, a device 1105, or a network entity 105 as described herein. The device 1305 may communicate wirelessly with one or more network entities 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting TAG determination for SUL). For example, the device 1305 or a component of the device 1305 may include a processor 1340 and memory 1330 coupled with or to the processor 1340, the processor 1340 and memory 1330 configured to perform various functions described herein.

The inter-station communications manager 1345 may manage communications with other network entities 105, and may include a controller or scheduler for controlling communications with UEs 115 in cooperation with other network entities 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between network entities 105.

The communications manager 1320 may support wireless communication at a network device in accordance with examples as disclosed herein. For example, the communications manager 1320 may be configured as or otherwise support a means for receiving a first uplink message using a first uplink carrier of a serving cell in accordance with a first TA value of a first TAG configured for a UE. The communications manager 1320 may be configured as or otherwise support a means for transmitting a TAG configuration indicating a supplementary TA value for a SUL carrier of the serving cell, the TAG configuration indicating that the supplementary TA value is one of the first TA value of the first TAG or a second TA value of a second TAG for the SUL carrier. The communications manager 1320 may be configured as or otherwise support a means for receiving a SUL message on the SUL carrier of the serving cell in accordance with the supplementary TA value based on the TAG configuration.

By including or configuring the communications manager 1320 in accordance with examples as described herein, the device 1305 may support techniques for improved communication reliability, reduced latency, improved user experience based on increased throughput, more efficient utilization of communication resources, improved coordination and synchronization between devices, and increased uplink coverage and performance.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of TAG determination for SUL as described herein, or the processor 1340 and the memory 1330 may be otherwise configured to perform or support such operations.

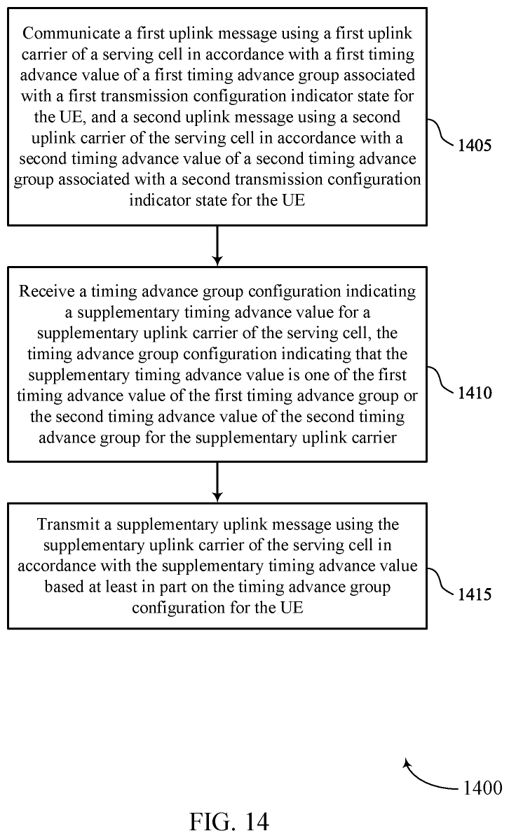

FIG. 14 shows a flowchart illustrating a method 1400 that supports TAG determination for SUL in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE. The operations of 1405 may be performed in accordance with examples as disclosed herein. In some examples, aspects of the operations of 1405 may be performed by an uplink communications component 825 as described with reference to FIG. 8.

At 1410, the method may include receiving a TAG configuration indicating a supplementary TA value for a SUL carrier of the serving cell, the TAG configuration indicating that the supplementary TA value is one of the first TA value of the first TAG or the second TA value of the second TAG for the SUL carrier. The operations of 1410 may be performed in accordance with examples as disclosed herein. In some examples, aspects of the operations of 1410 may be performed by a TA application component 830 as described with reference to FIG. 8.

At 1415, the method may include transmitting a SUL message using the SUL carrier of the serving cell in accordance with the supplementary TA value based on the TAG configuration for the UE. The operations of 1415 may be performed in accordance with examples as disclosed herein. In some examples, aspects of the operations of 1415 may be performed by an SUL TA configuration component 835 as described with reference to FIG. 8.

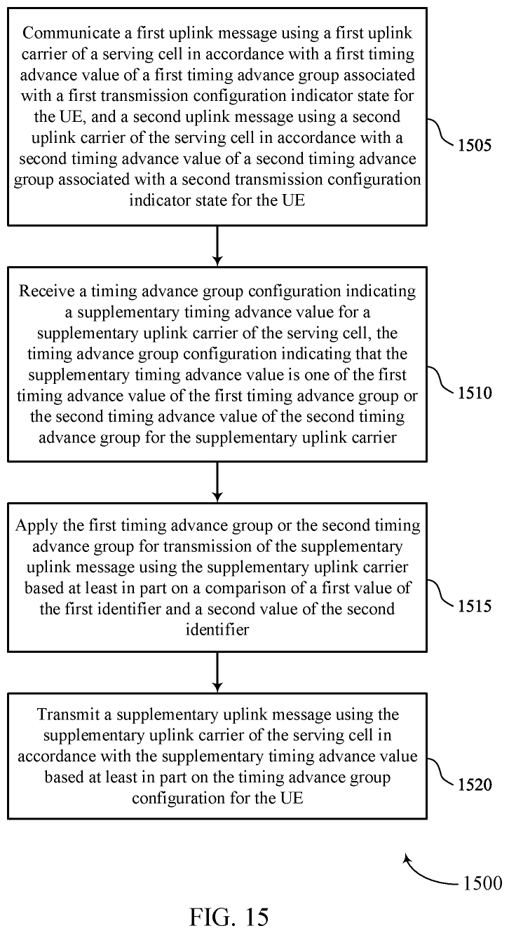

FIG. 15 shows a flowchart illustrating a method 1500 that supports TAG determination for SUL in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE. The operations of 1505 may be performed in accordance with examples as disclosed herein. In some examples, aspects of the operations of 1505 may be performed by an uplink communications component 825 as described with reference to FIG. 8.

At 1510, the method may include receiving a TAG configuration indicating a supplementary TA value for a SUL carrier of the serving cell, the TAG configuration indicating that the supplementary TA value is one of the first TA value of the first TAG or the second TA value of the second TAG for the SUL carrier. The operations of 1510 may be performed in accordance with examples as disclosed herein. In some examples, aspects of the operations of 1510 may be performed by a TA application component 830 as described with reference to FIG. 8.

At 1515, the method may include applying the first TAG or the second TAG for transmission of the SUL message using the SUL carrier based on a comparison of a first value of the first identifier and a second value of the second identifier. The operations of 1515 may be performed in accordance with examples as disclosed herein. In some examples, aspects of the operations of 1515 may be performed by an SUL TA identifier component 840 as described with reference to FIG. 8.

At 1520, the method may include transmitting a SUL message using the SUL carrier of the serving cell in accordance with the supplementary TA value based on the TAG configuration for the UE. The operations of 1520 may be performed in accordance with examples as disclosed herein. In some examples, aspects of the operations of 1520 may be performed by an SUL TA configuration component 835 as described with reference to FIG. 8.

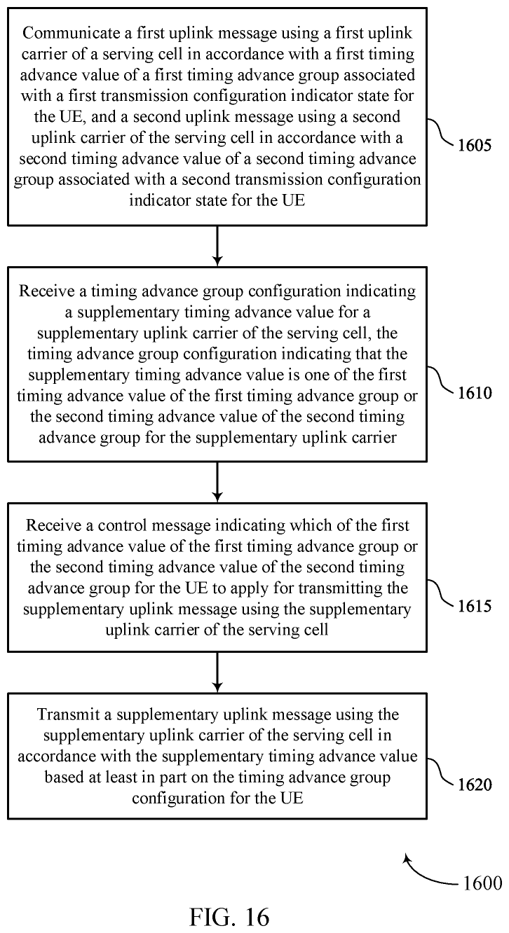

FIG. 16 shows a flowchart illustrating a method 1600 that supports TAG determination for SUL in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE. The operations of 1605 may be performed in accordance with examples as disclosed herein. In some examples, aspects of the operations of 1605 may be performed by an uplink communications component 825 as described with reference to FIG. 8.

At 1610, the method may include receiving a TAG configuration indicating a supplementary TA value for a SUL carrier of the serving cell, the TAG configuration indicating that the supplementary TA value is one of the first TA value of the first TAG or the second TA value of the second TAG for the SUL carrier. The operations of 1610 may be performed in accordance with examples as disclosed herein. In some examples, aspects of the operations of 1610 may be performed by a TA application component 830 as described with reference to FIG. 8.

At 1615, the method may include receiving a control message indicating which of the first TA value of the first TAG or the second TA value of the second TAG for the UE to apply for transmitting the SUL message using the SUL carrier of the serving cell. The operations of 1615 may be performed in accordance with examples as disclosed herein. In some examples, aspects of the operations of 1615 may be performed by an RRC receiving component 845 as described with reference to FIG. 8.

At 1620, the method may include transmitting a SUL message using the SUL carrier of the serving cell in accordance with the supplementary TA value based on the TAG configuration for the UE. The operations of 1620 may be performed in accordance with examples as disclosed herein. In some examples, aspects of the operations of 1620 may be performed by an SUL TA configuration component 835 as described with reference to FIG. 8.

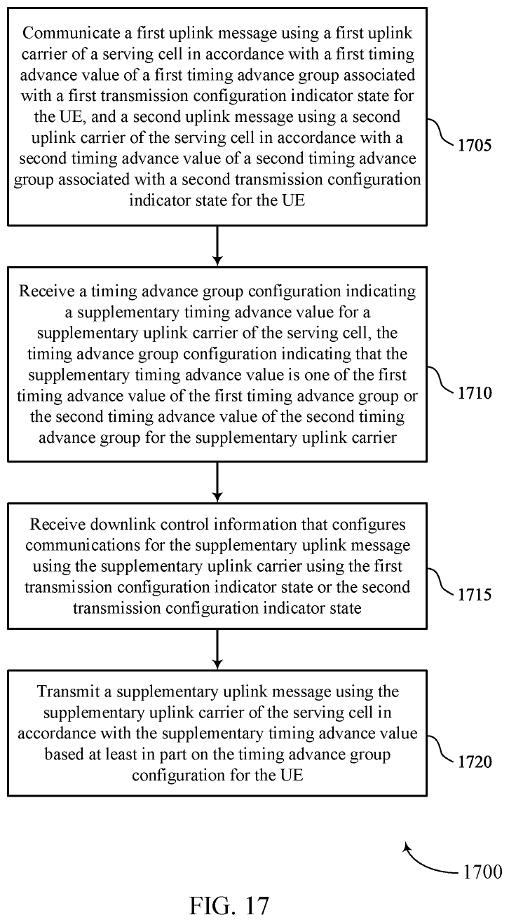

FIG. 17 shows a flowchart illustrating a method 1700 that supports TAG determination for SUL in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE. The operations of 1705 may be performed in accordance with examples as disclosed herein. In some examples, aspects of the operations of 1705 may be performed by an uplink communications component 825 as described with reference to FIG. 8.

At 1710, the method may include receiving a TAG configuration indicating a supplementary TA value for a SUL carrier of the serving cell, the TAG configuration indicating that the supplementary TA value is one of the first TA value of the first TAG or the second TA value of the second TAG for the SUL carrier. The operations of 1710 may be performed in accordance with examples as disclosed herein. In some examples, aspects of the operations of 1710 may be performed by a TA application component 830 as described with reference to FIG. 8.

At 1715, the method may include receiving DCI that configures communications for the SUL message using the SUL carrier using the first transmission configuration indicator state or the second transmission configuration indicator state. The operations of 1715 may be performed in accordance with examples as disclosed herein. In some examples, aspects of the operations of 1715 may be performed by a DCI receiving component 850 as described with reference to FIG. 8.

At 1720, the method may include transmitting a SUL message using the SUL carrier of the serving cell in accordance with the supplementary TA value based on the TAG configuration for the UE. The operations of 1720 may be performed in accordance with examples as disclosed herein. In some examples, aspects of the operations of 1720 may be performed by an SUL TA configuration component 835 as described with reference to FIG. 8.

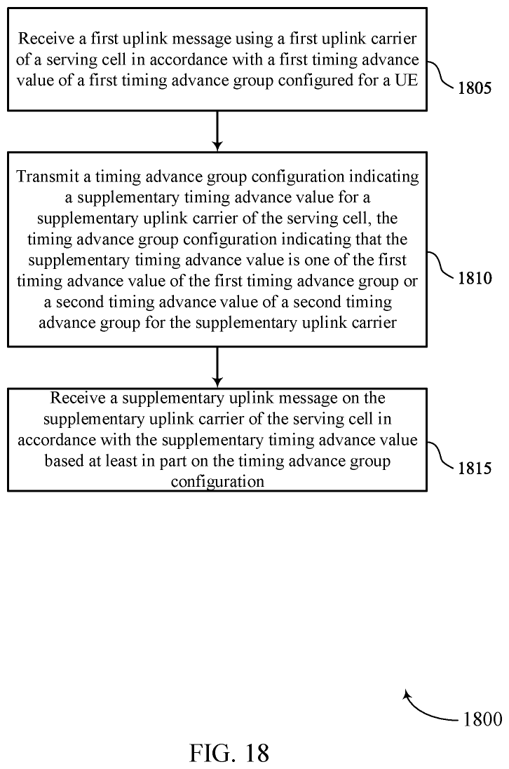

FIG. 18 shows a flowchart illustrating a method 1800 that supports TAG determination for SUL in accordance with aspects of the present disclosure. The operations of the method 1800 may be implemented by a network entity or its components as described herein. For example, the operations of the method 1800 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1805, the method may include receiving a first uplink message using a first uplink carrier of a serving cell in accordance with a first TA value of a first TAG configured for a UE. The operations of 1805 may be performed in accordance with examples as disclosed herein. In some examples, aspects of the operations of 1805 may be performed by an uplink communications receiving component 1225 as described with reference to FIG. 12.

At 1810, the method may include transmitting a TAG configuration indicating a supplementary TA value for a SUL carrier of the serving cell, the TAG configuration indicating that the supplementary TA value is one of the first TA value of the first TAG or a second TA value of a second TAG for the SUL carrier. The operations of 1810 may be performed in accordance with examples as disclosed herein. In some examples, aspects of the operations of 1810 may be performed by a TA configuration component 1230 as described with reference to FIG. 12.

At 1815, the method may include receiving a SUL message on the SUL carrier of the serving cell in accordance with the supplementary TA value based on the TAG configuration. The operations of 1815 may be performed in accordance with examples as disclosed herein. In some examples, aspects of the operations of 1815 may be performed by an SUL communications receiving component 1235 as described with reference to FIG. 12.

The following provides an overview of aspects of the present disclosure:

Aspect 1: A method for wireless communication at a UE, comprising: communicating a first uplink message using a first uplink carrier of a serving cell in accordance with a first TA value of a first TAG associated with a first transmission configuration indicator state for the UE, and a second uplink message using a second uplink carrier of the serving cell in accordance with a second TA value of a second TAG associated with a second transmission configuration indicator state for the UE; receiving a TAG configuration indicating a supplementary TA value for a SUL carrier of the serving cell, the TAG configuration indicating that the supplementary TA value is one of the first TA value of the first TAG or the second TA value of the second TAG for the SUL carrier; and transmitting a SUL message using the SUL carrier of the serving cell in accordance with the supplementary TA value based at least in part on the TAG configuration for the UE.

Aspect 2: The method of aspect 1, wherein the TAG configuration indicates a first identifier associated with the first TAG and a second identifier associated with the second TAG, the method further comprising: applying the first TAG or the second TAG for transmission of the SUL message using the SUL carrier based at least in part on a comparison of a first value of the first identifier and a second value of the second identifier.

Aspect 3: The method of aspect 2, wherein the comparison further comprises: applying the first TA value of the first TAG for transmission of the SUL message using the SUL carrier based at least in part on the first value of the first identifier being greater than the second value of the second identifier.

Aspect 4: The method of any of aspects 2 through 3, wherein the comparison further comprises: applying the first TA value of the first TAG for transmission of the SUL message using the SUL carrier based at least in part on the first value of the first identifier being less than the second value of the second identifier.

Aspect 5: The method of any of aspects 2 through 4, wherein the first identifier and the second identifier comprise transmission reception point identifiers, control resource set pool index identifiers, TAG identifiers, or any combination thereof.

Aspect 6: The method of any of aspects 1 through 5, further comprising: receiving a control message indicating which of the first TA value of the first TAG or the second TA value of the second TAG for the UE to apply for transmitting the SUL message using the SUL carrier of the serving cell.

Aspect 7: The method of aspect 6, wherein receiving the control message comprises: receiving a serving cell configuration that includes a TAG identifier, the TAG identifier indicating the first TA value of the first TAG or the second TA value of the second TAG.

Aspect 8: The method of any of aspects 6 through 7, wherein receiving the control message comprises: receiving a RRC message indicating the TAG configuration.

Aspect 9: The method of any of aspects 1 through 8, further comprising: receiving DCI that configures communications for the SUL message using the SUL carrier using the first transmission configuration indicator state or the second transmission configuration indicator state.

Aspect 10: The method of aspect 9, wherein the DCI indicates that the UE apply the first TA value of the first TAG for transmission of the SUL message using the SUL carrier based at least in part on the DCI being associated with the first transmission configuration indicator state, a first control resource set pool index, or both.

Aspect 11: The method of any of aspects 9 through 10, wherein the DCI indicates that the UE apply the second TA value of the second TAG for transmission of the SUL message using the SUL carrier based at least in part on the DCI being associated with the second transmission configuration indicator state, a second control resource set pool index, or both.

Aspect 12: The method of any of aspects 9 through 11, further comprising: receiving a RRC message that indicates the first TA value of the first TAG and the second TA value of the second TAG; receiving the DCI in accordance with the RRC message; and selecting the first TA value of the first TAG or the second TA value of the second TAG for transmission of the SUL message based at least in part on the DCI.

Aspect 13: A method for wireless communication at a network device, comprising: receiving a first uplink message using a first uplink carrier of a serving cell in accordance with a first TA value of a first TAG configured for a UE; transmitting a TAG configuration indicating a supplementary TA value for a SUL carrier of the serving cell, the TAG configuration indicating that the supplementary TA value is one of the first TA value of the first TAG or a second TA value of a second TAG for the SUL carrier; and receiving a SUL message on the SUL carrier of the serving cell in accordance with the supplementary TA value based at least in part on the TAG configuration.

Aspect 14: The method of aspect 13, further comprising: transmitting a control message indicating which one of the first TA value of the first TAG or the second TA value of the second TAG to apply for transmission of the SUL message.

Aspect 15: The method of aspect 14, wherein transmitting the control message comprises: transmitting a serving cell configuration that includes a TAG identifier indicating the first TAG or the second TAG.

Aspect 16: The method of any of aspects 14 through 15, wherein transmitting the control message comprises: transmitting a RRC message indicating the TAG configuration.

Aspect 17: The method of any of aspects 13 through 16, further comprising: transmitting DCI including the TAG configuration that indicates which one of the first TA value of the first TAG or the second TA value of the second TAG to apply for transmission of the SUL message.

Aspect 18: The method of aspect 17, wherein the DCI indicates that the UE apply the first TA value of the first TAG for transmission of the SUL message based at least in part on the DCI, a first control resource set pool index, or both.

Aspect 19: The method of any of aspects 17 through 18, wherein the DCI indicates that the UE apply the second TA value of the second TAG for transmission of the SUL message based at least in part on the DCI, a second control resource set pool index, or both.

Aspect 20: The method of any of aspects 13 through 19, wherein the TAG configuration indicates the first TA value of the first TAG or the second TA value of the second TAG based at least in part on a first identifier associated with the first TAG and a second identifier associated with the second TAG.

Aspect 21: The method of aspect 20, wherein the first identifier and the second identifier comprise transmission reception point identifiers, control resource set pool index identifiers, TAG identifiers, or any combination thereof.

Aspect 22: An apparatus for wireless communication at a UE, comprising a processor; memory coupled with the processor; and instructions stored in the memory and executable by the processor to cause the apparatus to perform a method of any of aspects 1 through 12.

Aspect 23: An apparatus for wireless communication at a UE, comprising at least one means for performing a method of any of aspects 1 through 12.

Aspect 24: A non-transitory computer-readable medium storing code for wireless communication at a UE, the code comprising instructions executable by a processor to perform a method of any of aspects 1 through 12.

Aspect 25: An apparatus for wireless communication at a network device, comprising a processor; memory coupled with the processor; and instructions stored in the memory and executable by the processor to cause the apparatus to perform a method of any of aspects 13 through 21.

Aspect 26: An apparatus for wireless communication at a network device, comprising at least one means for performing a method of any of aspects 13 through 21.

Aspect 27: A non-transitory computer-readable medium storing code for wireless communication at a network device, the code comprising instructions executable by a processor to perform a method of any of aspects 13 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a memory; and
a processor coupled to the memory and configured to:
communicate a first uplink message using a first uplink carrier of a serving cell in accordance with a first timing advance value of a first timing advance group associated with a first transmission configuration indicator state for the UE, and a second uplink message using a second uplink carrier of the serving cell in accordance with a second timing advance value of a second timing advance group associated with a second transmission configuration indicator state for the UE;
receive a timing advance group configuration indicating a supplementary timing advance value for a supplementary uplink carrier of the serving cell, the timing advance group configuration indicating that the supplementary timing advance value is one of the first timing advance value of the first timing advance group or the second timing advance value of the second timing advance group for the supplementary uplink carrier; and
transmit a supplementary uplink message using the supplementary uplink carrier of the serving cell in accordance with the supplementary timing advance value based at least in part on the timing advance group configuration for the UE.

2. The apparatus of claim 1, wherein the timing advance group configuration indicates a first identifier associated with the first timing advance group and a second identifier associated with the second timing advance group, and the processor coupled to the memory is further configured to cause the apparatus to:
apply the first timing advance group or the second timing advance group for transmission of the supplementary uplink message using the supplementary uplink carrier based at least in part on a comparison of a first value of the first identifier and a second value of the second identifier.

3. The apparatus of claim 2, wherein the processor coupled to the memory is further configured to cause the apparatus to:
apply the first timing advance value of the first timing advance group for transmission of the supplementary uplink message using the supplementary uplink carrier based at least in part on the first value of the first identifier being greater than the second value of the second identifier.

4. The apparatus of claim 2, wherein the processor coupled to the memory is further configured to cause the apparatus to:
apply the first timing advance value of the first timing advance group for transmission of the supplementary uplink message using the supplementary uplink carrier based at least in part on the first value of the first identifier being less than the second value of the second identifier.

5. The apparatus of claim 2, wherein the first identifier and the second identifier comprise transmission reception point identifiers, control resource set pool index identifiers, timing advance group identifiers, or any combination thereof.

6. The apparatus of claim 1, the processor coupled to the memory is further configured to cause the apparatus to:
receive a control message indicating which of the first timing advance value of the first timing advance group or the second timing advance value of the second timing advance group for the UE to apply for transmitting the supplementary uplink message using the supplementary uplink carrier of the serving cell.

7. The apparatus of claim 6, the processor coupled to the memory is further configured to cause the apparatus to:
receive a serving cell configuration that includes a timing advance group identifier, the timing advance group identifier indicating the first timing advance value of the first timing advance group or the second timing advance value of the second timing advance group.

8. The apparatus of claim 6, wherein receiving the control message by the processor coupled to the memory is further configured to cause the apparatus to:
receive a radio resource control message indicating the timing advance group configuration.

9. The apparatus of claim 1, wherein the processor coupled to the memory is further configured to cause the apparatus to:
receive downlink control information that configures communications for the supplementary uplink message using the supplementary uplink carrier using the first transmission configuration indicator state or the second transmission configuration indicator state.

10. The apparatus of claim 9, wherein the downlink control information indicates that the UE apply the first timing advance value of the first timing advance group for transmission of the supplementary uplink message using the supplementary uplink carrier based at least in part on the downlink control information being associated with the first transmission configuration indicator state, a first control resource set pool index, or both.

11. The apparatus of claim 9, wherein the downlink control information indicates that the UE apply the second timing advance value of the second timing advance group for transmission of the supplementary uplink message using the supplementary uplink carrier based at least in part on the downlink control information being associated with the second transmission configuration indicator state, a second control resource set pool index, or both.

12. The apparatus of claim 9, wherein the processor coupled to the memory is further configured to cause the apparatus to:
receive a radio resource control message that indicates the first timing advance value of the first timing advance group and the second timing advance value of the second timing advance group;
receive the downlink control information in accordance with the radio resource control message; and
select the first timing advance value of the first timing advance group or the second timing advance value of the second timing advance group for transmission of the supplementary uplink message based at least in part on the downlink control information.

13. An apparatus for wireless communication at a network device, comprising:
a memory; and
a processor coupled to the memory and configured to:
receive a first uplink message using a first uplink carrier of a serving cell in accordance with a first timing advance value of a first timing advance group configured for a user equipment (UE);
transmit a timing advance group configuration indicating a supplementary timing advance value for a supplementary uplink carrier of the serving cell, the timing advance group configuration indicating that the supplementary timing advance value is one of the first timing advance value of the first timing advance group or a second timing advance value of a second timing advance group for the supplementary uplink carrier; and
receive a supplementary uplink message on the supplementary uplink carrier of the serving cell in accordance with the supplementary timing advance value based at least in part on the timing advance group configuration.

14. The apparatus of claim 13, wherein the processor coupled to the memory is further configured to cause the apparatus to:
transmit a control message indicating which one of the first timing advance value of the first timing advance group or the second timing advance value of the second timing advance group to apply for transmission of the supplementary uplink message.

15. The apparatus of claim 14, wherein transmitting the control message by the processor coupled to the memory is further configured to cause the apparatus to:
transmit a serving cell configuration that includes a timing advance group identifier indicating the first timing advance group or the second timing advance group.

16. The apparatus of claim 14, wherein transmitting the control message by the processor coupled to the memory is further configured to cause the apparatus to:
transmit a radio resource control message indicating the timing advance group configuration.

17. The apparatus of claim 13, wherein the processor coupled to the memory is further configured to cause the apparatus to:
transmit downlink control information including the timing advance group configuration that indicates which one of the first timing advance value of the first timing advance group or the second timing advance value of the second timing advance group to apply for transmission of the supplementary uplink message.

18. The apparatus of claim 17, wherein the downlink control information indicates that the UE apply the first timing advance value of the first timing advance group for transmission of the supplementary uplink message based at least in part on the downlink control information, a first control resource set pool index, or both.

19. The apparatus of claim 17, wherein the downlink control information indicates that the UE apply the second timing advance value of the second timing advance group for transmission of the supplementary uplink message based at least in part on the downlink control information, a second control resource set pool index, or both.

20. The apparatus of claim 13, wherein the timing advance group configuration indicates the first timing advance value of the first timing advance group or the second timing advance value of the second timing advance group based at least in part on a first identifier associated with the first timing advance group and a second identifier associated with the second timing advance group.

21. The apparatus of claim 20, wherein the first identifier and the second identifier comprise transmission reception point identifiers, control resource set pool index identifiers, timing advance group identifiers, or any combination thereof.

22. A method for wireless communication at a user equipment (UE), comprising:
communicating a first uplink message using a first uplink carrier of a serving cell in accordance with a first timing advance value of a first timing advance group associated with a first transmission configuration indicator state for the UE, and a second uplink message using a second uplink carrier of the serving cell in accordance with a second timing advance value of a second timing advance group associated with a second transmission configuration indicator state for the UE;
receiving a timing advance group configuration indicating a supplementary timing advance value for a supplementary uplink carrier of the serving cell, the timing advance group configuration indicating that the supplementary timing advance value is one of the first timing advance value of the first timing advance group or the second timing advance value of the second timing advance group for the supplementary uplink carrier; and
transmitting a supplementary uplink message using the supplementary uplink carrier of the serving cell in accordance with the supplementary timing advance value based at least in part on the timing advance group configuration for the UE.

23. The method of claim 22, wherein the timing advance group configuration indicates a first identifier associated with the first timing advance group and a second identifier associated with the second timing advance group, the method further comprising:
applying the first timing advance group or the second timing advance group for transmission of the supplementary uplink message using the supplementary uplink carrier based at least in part on a comparison of a first value of the first identifier and a second value of the second identifier.

24. The method of claim 23, wherein the comparison further comprises:
applying the first timing advance value of the first timing advance group for transmission of the supplementary uplink message using the supplementary uplink carrier based at least in part on the first value of the first identifier being greater than the second value of the second identifier.

25. The method of claim 23, wherein the comparison further comprises:
applying the first timing advance value of the first timing advance group for transmission of the supplementary uplink message using the supplementary uplink carrier based at least in part on the first value of the first identifier being less than the second value of the second identifier.

26. The method of claim 23, wherein the first identifier and the second identifier comprise transmission reception point identifiers, control resource set pool index identifiers, timing advance group identifiers, or any combination thereof.

27. The method of claim 22, further comprising:
receiving a control message indicating which of the first timing advance value of the first timing advance group or the second timing advance value of the second timing advance group for the UE to apply for transmitting the supplementary uplink message using the supplementary uplink carrier of the serving cell.

28. The method of claim 27, wherein receiving the control message comprises:
receiving a radio resource control message indicating the timing advance group configuration.

29. The method of claim 22, further comprising:
receiving downlink control information that configures communications for the supplementary uplink message using the supplementary uplink carrier using the first transmission configuration indicator state or the second transmission configuration indicator state.

30. A method for wireless communication at a network device, comprising:
receiving a first uplink message using a first uplink carrier of a serving cell in accordance with a first timing advance value of a first timing advance group configured for a user equipment (UE);
transmitting a timing advance group configuration indicating a supplementary timing advance value for a supplementary uplink carrier of the serving cell, the timing advance group configuration indicating that the supplementary timing advance value is one of the first timing advance value of the first timing advance group or a second timing advance value of a second timing advance group for the supplementary uplink carrier; and
receiving a supplementary uplink message on the supplementary uplink carrier of the serving cell in accordance with the supplementary timing advance value based at least in part on the timing advance group configuration.
